(19) United States
(12) Patent Application Publication
(10) Pub. No.: US 2012/0090984 A1
(43) Pub. Date: Apr. 19, 2012

(54) METHOD AND APPARATUS FOR PURIFYING A SILICON FEEDSTOCK

(75) Inventor: Maxime Labrot, Bordeaux (FR)

(73) Assignee: SILIMELT, PESSAC (FR)

(21) Appl. No.: 13/264,858

(22) PCT Filed: Apr. 16, 2010
(86) PCT No.: PCT/EP10/55059

§ 371 Date: Dec. 28, 2011

(30) Foreign Application Priority Data
Apr. 17, 2009 (FR) 0952532

(51) Int. Cl. B01J 19/08; H05H 1/32

(52) U.S. Cl. 204/164; 422/186.04

(57) ABSTRACT

A method for purifying a silicon-based load to obtain extra-pure silicon, includes:

a) directing a plasma jet from an initial non-transferred arc torch onto a solid wall of a volume having an outlet to generate a homogeneous plasma flow,

b) continuously injecting a silicon-based load having particles and/or grains, or crushed, into the homogeneous plasma flow to obtain an assembly,

c) continuously directing the assembly from the outlet towards a melting pot having heating elements and stirring the crushed load into a molten state,

d) once the entire crushed load has been injected and a molten bath formed inside the melting pot, directing the plasma jet from at least a second non-transferred arc torch onto the surface of the bath,

e) removing the slag on the surface of the bath, and possibly repeating steps d) and e) to volatilize some of the bath impurities brought to the surface due to stirring.

The present invention concerns a method for purifying a silicon-based load and an apparatus for the implementation thereof.

It is common knowledge that the production of photovoltaic silicon is currently insufficient to meet current market needs, a market undergoing rapid growth due to the interest in renewable energies. For years, supplies have derived from electronic silicon waste, said material now becoming more and more scarce, thus causing a price increase incompatible with the planned market expansion.

Even though research has been conducted using materials other than silicon for the purpose of transforming light energy into thermal or electrical energy, silicon remains the reference material.

Hence, other sectors for manufacturing photovoltaic silicon are being actively explored, either by simplified chemical means in relation to that already implemented for producing electronic silicon, or by high temperature electrochemical means.

The photovoltaic industry requires excessively pure silicon for the production of photovoltaic cells, or solar cells. Said photovoltaic silicon is a polycrystalline silicon with a silicon content equalling 99.9999%. The remainder, 100 ppm, is comprised of impurities whose respective levels should remain within the following limits:
boron <0.3 ppm,
phosphorus <1 ppm,
total metallic impurities <100 ppm,
carbon <10 ppm,
oxygen <10 ppm.

Metallurgical silicon having a low purity level, it is thus necessary to purify it in order to produce photovoltaic-grade silicon.

There are numerous methods for purifying metallurgical silicon in order to remove the impurities contained therein, notably boron and phosphorus.

U.S. Pat. No. 4,354,987 illustrates a method of compaction, after melting, of already-purified silicon powder, using inductive heating by way of a graphite susceptor.

Patent numbers FR 2 487 608 and FR 2 585 690 also describe the purification of silicon under inductive plasma using an argon, hydrogen and oxygen plasmagene mixture. U.S. Pat. No. 4,379,777 describes a plasma-processing method for metallurgical silicon using an inductive plasma torch operating with an argon/hydrogen mixture.

It is clear that much research has been conducted for several decades for the purpose of purifying metallurgical silicon, with the aim of achieving competitive prices for said photovoltaic quality.

In particular, many studies have been devoted to the use of thermal plasma, sometimes combined with an electromagnetic or resistive mode of heating, in order to melt and purify metallurgical silicon.

Nevertheless, all these methods illustrate at least one of the following disadvantages:
the required purification level is obtained by way of complex processes involving several steps. As an example, the document entitled “Thermodynamics of solar grade silicon refining” (Intermetallics Review 2003, 1111-1117) provides a comprehensive analysis leading to the proposal of a metallurgical silicon purification process comprising no less than five steps for attaining photovoltaic quality: the addition of calcium, acid lixiviation, oxidative refining, vacuum processing and controlled solidification, each step having the role of preparing and/or extracting specific impurities.
the desired result can also be achieved by directly adding flux into a silicon molten bath.

In all cases, the quantities of photovoltaic silicon produced remain marginal and the energy reports unfavourable, since they are burdened either by the addition of materials to facilitate the elimination of the impurities or by the multiplication of steps within the method, or by both.

It should be noted that to date, no industrial plant is yet up and running, nor exists on a scale possibly compatible with the market needs and the necessary cost reductions.

If we insist on using thermal plasma, it is clear that the inductive plasma torch, attractive in terms of its non-contaminating characteristics, is nevertheless extremely hindered on the one hand in terms of its functioning due to alteration caused by the injection of the products to be processed, and by a limited power range on the other.

The aim of the invention is to provide a method and an apparatus for purifying a silicon-based load, such as metallurgical silicon, thereby enabling to overcome said disadvantages of the prior art.

Advantageously, the present invention is based on an enhanced use of the arc thermal plasma, limiting, without any energy break, the steps of a method ultimately leading to the photovoltaic quality. It also enables to produce, within an industrial set-up, large quantities of photovoltaic grade silicon derived from metallurgical silicon.

Hence, the present invention relates to a method for purifying a silicon-based load in view of obtaining extra-pure silicon.

According to the invention, said method comprises the following successive steps:

a) a plasma jet generated by an initial non-transferred arc torch is directed onto a solid wall of a volume equipped with an outlet so that the impact of said jet against said solid wall inside said volume generates a homogeneous plasma flow,

b) a silicon-based load to be processed, constituted of particles and/or grains, or even crushed, is continuously injected into said homogeneous plasma flow,

c) the assembly formed by the homogeneous plasma into which the load has been injected is continuously directed from the outlet of said volume towards a melting pot equipped with lateral walls and a base and an open upper part, said melting pot comprising means for heating and stirring said crushed load into a molten state,

d) once the entire load has been injected and a molten bath has been formed inside said melting pot, the reactive plasma jet from at least a second non-transferred arc torch is directed onto the surface of said bath in order to volatilize at least certain impurities from the molten bath present on the surface of said bath,

e) the slag on the surface of said bath is removed, and steps d) and e) are possibly repeated in order to volatilize at least some of the impurities of the bath brought to the surface of said bath due to stirring,

f) said molten bath is then emptied.

The purification method of the invention thus aims to process the crushed silicon-based loads or the silicon-based loads comprised of particles and/or grains in said homogeneous plasma flow in the form of batches. Preferably, the processing of a crushed load batch should be enough to fill the melting pot.

Said silicon-based loads should preferably be loads of silica, silicate, quartz, metallurgical silicon or combinations of said elements.

As a simple illustration, said silicon-based loads comprised of particles and/or grains may contain sand with a granulometry lower than 5 mm, preferably between 0.4 mm and 1.3 mm.

Said silicon-based loads may further comprise one or more additives, such as carbon black, resulting, for example, from biomass combustion.

The homogenisation of the plasma jet generated by the first non-transferred arc torch enables to create a homogenous plasma flow, notably in terms of temperature. Said homogeneity of the plasma flow allows a uniform processing of the injected crushed load.

Advantageously, at the outlet of the injection enclosure, the assembly obtained from injecting said crushed load into said homogeneous plasma flow is of sufficient size so as not to provoke projections deriving from the molten bath.

Preferably, said assembly is dispatched within the central portion of the upper opening of the melting pot, while the reactive plasma jet generated by at least one other non-transferred arc torch is sent away from the walls of the melting pot in order to prevent the creation of hot points on said walls.

In order to ensure the processing of certain impurities contained in the molten bath, the latter shall be stirred electromagnetically so that its impurities may be accumulated on the surface of the molten bath in order to be vaporised by one or several plasma jets emitted by one or several non-transferred arc plasma torches. Said electromagnetic stirring may be conducted by any electromagnetic mixer, such as by way of inductive heating means.

Typically, the jet or jets of reactive plasma will interact with the surface of the molten bath in order to allow the volatilization of certain impurities from the bath present on the surface of said bath. The electromagnetic stirring of the bath ensures renewal of said interface to be purified on the surface of the bath. Advantageously, the other non-transferred arc plasma torch or torches are supplied with redox plasma-forming gas, such as H₂, CO₂, O₂, HCl, HF and combinations of said elements, in order to produce high-temperature oxidation-reducing chemical species that encourage the elimination, by vaporisation, of some of the impurities of the molten bath.

In various specific embodiments of said method of purification, each one having its particular advantages with many possible technical combinations:
at least one said jet of reactive plasma is a homogeneous and reactive plasma flow obtained via impact from the reactive plasma jet generated by at least said second non-transferred arc torch onto a solid wall of another volume having an outlet, said second torch being connected to said other volume,
the granulometry of said crushed load shall be comprised between 10 and 30,500 μm, and even better, between 80 and 150 μm,

in step b), the crushed load having been injected by means of a carrier gas, the ratio of the crushed load mass on the carrier gas mass should be above 20.

Preferably, said ratio shall be comprised between 20 and 100 so as not to cool down the plasma jet generated by the non-transferred arc torch placed inside the injection enclosure.
the carrier gas being a reactive gas in contact with the homogeneous plasma flow, a primary purification of the crushed load is embodied inside said homogeneous plasma flow,
   The carrier gas becomes reactive upon contact with the homogeneous plasma flow due to the transfer of energy of the latter with the carrier gas. Simply as an illustration, said carrier gas is a gas containing chlorine, such as HCl.
prior to step a), the distance between said solid wall and the outlet of the non-transferred arc torch is adjusted,
   Advantageously, said solid wall is placed in relation to the outlet of said non-transferred arc torch, in a zone where the measured temperature of the plasma jet within the axle of said plasma jet, failing existence of the solid wall, would be equal or almost equal to half the value of the measured average peak temperature of the plasma jet at the output of the non-transferred arc torch. Simply as an illustration, the distance between the outlet of the non-transferred arc plasma torch of said solid wall is approximately three to five times the diameter of the plasma jet measured at the output of said torch connected to the injection enclosure.
in step c), the molten bath is stirred electromagnetically,
in step d), the melting pot having a diameter D and a height H, namely D/H≧5, the reactive plasma jets of at least a second and a third non-transferred arc torch are dispatched onto the surface of the molten bath in order to volatilise at least some of the impurities of the molten bath present on the surface of said bath,
in step e), a single reactive plasma jet is directed onto the surface of the molten bath in order to give a slight movement to the slag in the direction of at least one evacuation outlet placed on the lateral walls of said melting pot, said reactive plasma jet being generated, possibly in turn, by the other non-transferred arc torches,
   Whilst one of the torches is working, thereby emitting a jet of reactive plasma, all other non-transferred arc torches used to process the impurities existing on the surface of the bath are turned off.
   Advantageously, the alternating stoppage of each of the non-transferred arc torches emitting a jet of plasma enables the progressive evacuation of the slag according to special directions.
the spatial volume of the homogeneous plasma flows is increased in order to avoid projections into said melting pot in step c) and in order to process a larger surface of said molten bath than in step d)
in step f), the molten bath, now purified of its impurities via the plasma, is emptied by controlling its speed of extraction, its temperature of extraction and the amount extracted,
   Hence, said solidification being embodied without further melting steps, ingots are thus obtained with an outer silicon shell full of impurities and a core containing extra-pure silicon. Hence, by simply removing said envelope, the extra-pure silicon is revealed.
   The method of the invention thus enables, in a single and unique molten bath cooling step, to obtain ingots with an outer silicon shell full of impurities, with the core of said ingots comprising the desired extra-pure silicon.
   Preferably, said ingots should directly take the form of a solar-grade silicon bar. They may, for example, represent a 40×40 cm² section.

The invention also concerns purification apparatus for implementing the purification process, such as described above. According to the invention, this apparatus comprises:
an injection enclosure comprising at one end a non-transferred arc plasma torch having a main axis, said torch being designed to generate a plasma jet having a propagation axis essentially centred on the main axis of said torch,
said injection enclosure comprising an angled portion equipped with an outlet, said angled portion positioned downstream of said plasma torch comprising a solid wall so that said plasma jet collides with said solid wall in order to form a homogeneous plasma flow,
said injection enclosure comprising at least one injection port placed downstream from said plasma torch for the continuous injection of a crushed load to be processed in view of its mixing with said homogeneous plasma flow,
the outlet of said injection enclosure is placed above a melting pot equipped with lateral walls and a base and an open upper part, said melting pot being designed to continuously receive said assembly formed by the homogenous plasma flow into which has been injected said crushed load until the complete injection of the latter in order to form a molten bath,
said melting pot comprising means for heating and stirring said molten bath into a molten state, one or several extraction ports placed on its lateral walls in order to evacuate the slag and at least one discharge port in order to empty said molten bath,
said apparatus comprising one or several other non-transferred arc plasma torches, each one for the purpose of generating a reactive plasma jet dispatched onto the surface of the molten bath in order to volatilise at least some of the impurities on the surface of said molten bath.
   The melting pot should, preferably, be of a cylindrical or oval shape, or of any other geometry having a symmetrical axis. Advantageously, the internal volume of said melting pot is defined by walls comprised of a non-polluting refractory material in relation to the silicon to be purified, for example, of the ultra-pure silica type. The melting pot may be rotated around a vertical axle in order to be tilted for the purpose of facilitating the evacuation of the slag. Said inclination may be by just a few degrees. The slag extraction outlets are, for example, evenly distributed around the circumference of the melting pot on the opposite side of the intersection zones of the plasma jets reacting with the surface of the molten bath.
   As a simple illustration, said extraction outlets are equipped with three slag film overflow notches fitted into the wall of the melting pot, each one 120° apart and diametrically opposite the points of intersection with the surface of the molten bath of the plasma jets, such as generated by the other non-transferred arc torches for processing the surface impurities.
   Of course, at least one said discharge port comprises means to ensure its obstruction, such as valves or electromagnetic means.

In various specific embodiments of said apparatus, each one with its particular advantages and having many possible technical combinations:
said apparatus comprises means for visualising the molten bath in order to determine the ideal moment for evacuating the slag,
the gas from said non-transferred arc torch placed on said injection enclosure is an inert gas or a reactive gas, such as H₂, CO₂, O₂, HCl, HF and combinations of said elements,
the non-transferred arc torches each comprise a downstream electrode, which is a flared electrode for the purpose of increasing the spatial volume of the plasma jet or of the generated reactive plasma,
   Preferably, each downstream electrode is a conical electrode. Its conicity angle may range from 1° to 2°.
the angled portion comprises at least one flared-shape portion in order to enable absorption of the flow of the crushed load injected into said homogeneous plasma flow, said flared-shape portion comprising at its tip the outlet of the injection enclosure.
   The wall of the angled portion with which the plasma jet collides may be slanted in relation to the propagation axle of said plasma jet, thereby limiting the transfer of energy to said wall.
   Said angled portion may adopt a flared shape as it nears the conically-shaped outlet of the enclosure, the half-apex angle of which being comprised between 10 and 30°.
the angled portion of each of the homogenisation enclosures comprises at least one flared-shaped portion on the tip of which is positioned the outlet of the corresponding homogenisation enclosure,
the apparatus comprises means for individually adjusting the distances between the outlets of the injection enclosure and the homogenisation enclosures, from the bottom of the melting pot or from the surface of said molten bath in order to optimise the energy reports and the extraction of the impurities,
each of the other said non-transferred arc torches generating a reactive plasma are connected to a corresponding homogenisation enclosure comprising an angled portion located downstream of said corresponding plasma torch, said angled portion including a solid wall so that said reactive plasma jet generated by said corresponding torch collides with said solid wall in order to form a homogeneous and reactive plasma flow,
said solid wall with which the plasma jet collides is placed in relation to the outlet of said torch linked to said injection enclosure, inside a zone where the measured temperature of the plasma jet within the axle of said plasma jet, failing existence of said solid wall, would be equal or substantially equal to half the value of the average peak temperature of the plasma jet measured at the output of said non-transferred arc torch.
said solid wall benefits from a translator movement in relation to the outlet of said non-transferred arc torch,
   Alternatively, the plasma torch placed at one end of the injection enclosure could be mobile in order to enable adjustment of the position of the solid wall in relation to the outlet of said non-transferred arc torch plasma.
the crushed load being injected via a carrier gas, at least one said crushed load injection port comprises at least one nozzle enabling a rotary injection of said crushed load,
   Said rotary injection enables to extend the staying time of the crushed load within the homogeneous plasma flow in order to ensure a proper thermal transfer from the plasma flow to the crushed load. In the case of a reactive carrier gas, said proper heat transfer also initiates the start of the purification process.
the plasma power of each of the non-transferred arc torches may be continuously adjusted by power adjustment means in order to optimise the energy reports and the elimination of impurities, thus preventing the creation of thermal shocks on the walls of the melting/purification pot,
linear measuring means enable to constantly determine the purity level of the material undergoing purification within the molten bath,
the melting pot comprises a diameter D and a height H, namely D/H≧5,
   As an example, said D/H ratio may be equal to 15.
   Advantageously, said shallow depth of the melting pot for such a large diameter increases the interface of the molten bath full of the impurities to be vaporised contained therein and facilitates elevation of the impurities to the surface due to stirring within said bath for the purpose of renewing said interface.
   Preferably, in this embodiment, the apparatus comprises at least two other non-transferred arc plasma torches. For example, for apparatus comprising three other non-transferred arc plasma torches, the intersection zones of the reactive plasma jets emitted by said other torches in relation to the surface of the molten bath are placed 120° apart on a circle with a radius comprised between one quarter and three quarters of the melting pot's radius.
the means for heating and stirring include one or several inductive coupling means, such as one or several induction coils,
the other torches are adjustable in order to move the reactive plasma jet that they generate onto the surface of the molten bath,
   Said movement of the plasma jet onto the surface of the molten bath notably enables to push the slag towards the extraction outlet or outlets.
said apparatus comprises means for adjusting the composition of the plasma-forming gas of each of the non-transferred arc torches whilst they are working,
the discharge outlet or outlets being placed at the bottom of the melting pot, said apparatus comprises containers for collecting the molten bath, said containers being placed on conveyance means in order to be presented one after the other beneath said discharge outlets until said melting pot has been emptied.
   Said conveyance means may comprise a linear conveyance chain or a mobile rotating carousel. Advantageously, the gravitational flow starts and stops in accordance with the sequential presentation of the containers under the melting pot. To each of said containers is adjoined a controlled atmospheric enclosure, itself linked to the melting pot for the transfer of the molten bath into the container.

Preferably, the apparatus shall further comprise leak-proof means of liaison for connecting each of the discharge outlets with the corresponding container in which the molten bath should be emptied.

The invention is described in more detail by referring to the attached sketches:

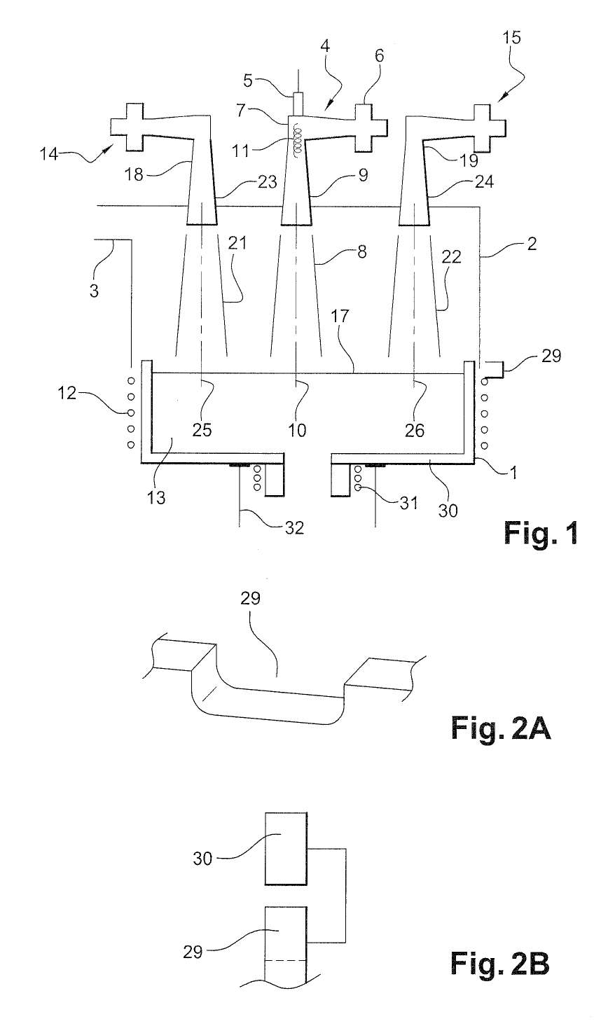

FIG. 1 schematically represents a cross-section of the purification apparatus according to a particular embodiment of the invention;

FIG. 2 is an enlarged view of the melting pot of the apparatus in FIG. 1 illustrating an extraction port for the slag with the collection means for said slag; FIG. 2 a) is a perspective view of said extraction outlet and FIG. 2b) is a sectional view;

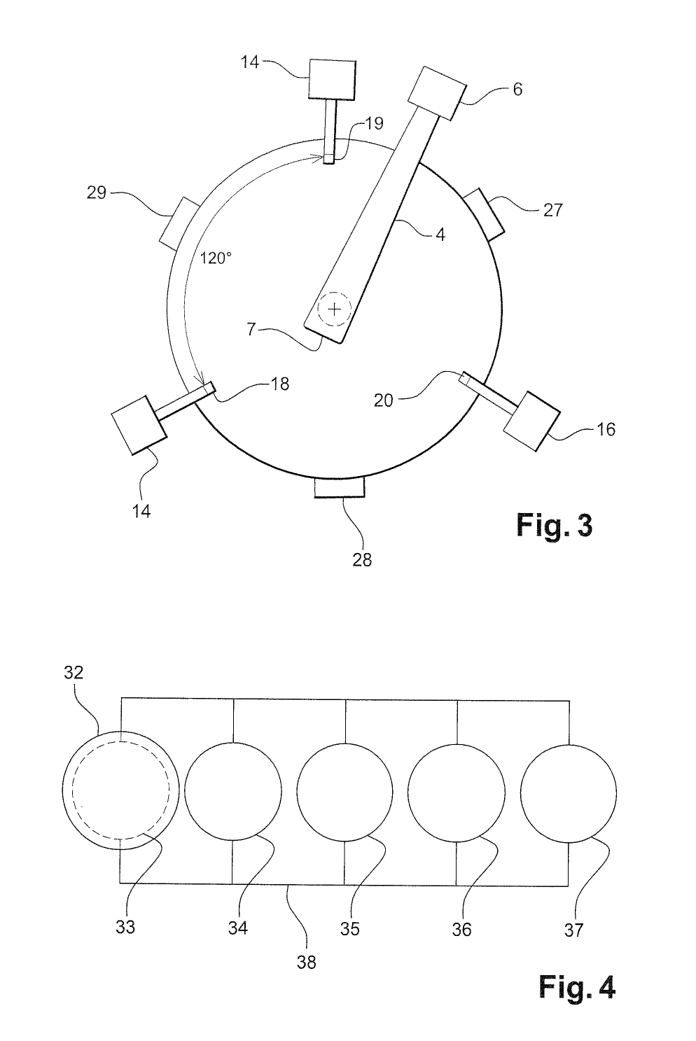

FIG. 3 is a view looking down on the apparatus in FIG. 1;

FIG. 4 is an enlarged view of the lower part of the apparatus in FIG. 1, illustrating the conveyance means of the containers underneath the discharge port;

FIG. 1 essentially shows a cross-section of a purification apparatus using plasma according to a particular embodiment of the invention that will be described herein in the context of the metallurgical silicon processing.

Said installation comprises a cylindrical-shaped melting/purification pot 1 coupled with a melting/purification enclosure 2, also of cylindrical shape and leak-proof in relation to the melting pot 1. The melting pot 1 and the enclosure 2 may, however, be of any other shape, e.g. oval. Said melting/purification enclosure 2 comprises a pipe 3, or funnel, for evacuating the gases present in the enclosure 2.
In a so-called pre-purification initial phase, a load of crushed silicon is continuously injected by way of a carrier gas into an injection enclosure 4, via an injector 5 whose outlet emerges on the wall of the injection enclosure 4. The latter comprises at one end a non-transferred arc plasma torch 6, which produces a plasma jet. Said jet collides with a solid wall 7 of the injection enclosure 4 in order to generate a homogenous plasma flow. Said flow is combined with the crushed silicon load and with the carrier gas, in order to produce a diphasic jet 8 at the outlet of a flared section 9 of the injection enclosure 4.
The diphasic jet 8 is directed, according to the axis 10 of the melting pot 1, in a vertical manner towards the melting/purification pot 1.
The injector 5, which is positioned so that the crushed silicon load follows a main trajectory according to the axle 10 of the diphasic jet, advantageously enables to confer secondary components on said main trajectory, for example a rotating component 11, in order to increase the staying time of the crushed silicon load inside the homogenous plasma flow/carrier gas mixture.
Said configuration provides the advantage of being able to issue a crushed silicon load flow, controlled in its output, irrespective of the plasma jet flow generated by the non-transferred arc torch 6 connected to the injection enclosure 4, while being fully processed inside the homogenous plasma flow. It also enables to start the melting/purification process as soon as the crushed silicon load has been injected, and to allow adjustable staying times.
The non-transferred arc plasma torch 6 provides energy, which is partially transferred, on the one hand to the crushed silicon load, and to the carrier gas on the other, said carrier gas, heated to a high temperature, forming the chemical reagent for igniting the purification process of the heated silicon inside the diphasic jet 8. The crushed silicon load having a granulometry comprised between 10 and 500 μm, and even better, between 80 and 150 μm, the silicon particles represent a maximum exchange surface.
The crushed silicon load, confined and conveyed by the diphasic jet 8, fills the melting/purification pot 1, bringing it to the pre-melted state due to the continuous supply of energy from the non-transferred arc plasma torch 6, the purification process still being active.
A high frequency electromagnetic field produced by an induction coil 12, brings the silicon contained in the melting pot 1 to the melted state, thus creating a stirred molten bath 13.
In addition to the non-transferred arc plasma torch 6 connected to the injection enclosure 4, the power of which being reduced when the induction coil 12 is activated, three other non-transferred arc torches 14, 15 and 16 (FIG. 3) are initiated in order to provide the plasma chemical reagents produced by them and which are necessary for continuing the purification process on the surface 17 of the molten bath 13.
Said surface 17 is continuously fed in the residual impurities by way of the electromagnetic stirring produced by the induction coil 12. The other three non-transferred arc plasma torches 14, 15 and 16 are respectively connected to the angled portions 18, 19 and 20 (FIG. 3), which become, respectively, the reactive plasma jets generated by these torches due to a collision between each reactive plasma jet and a solid wall of the corresponding angled portion in order to create homogeneous and reactive plasma flows 21, 22 (FIG. 1). Said angled portions respectively comprise flared sections 23, 24 that guide the homogeneous and reactive plasma flows in a substantially vertical manner towards the surface of the bath 17.
The non-transferred arc plasma torches 3, 14, 15 and 16 are each connected to the enclosure 2 by sealed devices (not illustrated), which moreover authorise orientation of the homogeneous plasma flows 8, 21, 22 in relation to the vertical of a maximum slanting angle of 10°.
The plasma torches 14, 15 and 16, and their associated angled portions 18, 19 and 20, are concentric to the outlet of the injection enclosure 4, the intersections of the axes 25, 26 of the homogeneous plasma flows 21, 22 with the surface 17 being spaced out every 120° around a circle whose radius is comprised between one quarter and three quarters of the radius of the melting pot 1.
The distance between the torches 3, 14, 15, 16 and the surface 17 of the bath, or even the bottom of the melting pot, is adjustable by moving the melting pot 1 in relation to the enclosure 2, while maintaining the seal between the enclosure 2 and the melting pot 1.
Said mobility increases the thermal and thermo-chemical efficiency of the torches in relation to the surface of the bath 17.
The slag film that may form on the surface of the bath, to the detriment of the efficiency of extracting the impurities, is evacuated at regular intervals. The slag is received via three notches 27-29, arranged in the melting pot 1 just beneath the surface of the bath 17 when the melting pot 1 is full (FIG. 2). Said notches 27-29 are confronted, during travelling of the melting pot in relation to the enclosure 2, with interfaces 30 fixed onto the enclosure 2 and comprised of identical or similar material to that of the melting pot 1.
In the melting/purification operating mode, the interfaces 30 respectively come and rest inside the notches 27-29 in order to maintain the level 17 of the bath 13. In the slag evacuation mode, the vertical movement towards the bottom of the melting pot 1, by several millimetres, frees up the outlets, thus enabling the passage of the slag. The notches 27-29 are, respectively, diametrically opposite the impact zones of the homogeneous plasma flows 21, 22 in relation to the surface of the bath 17.
In order to drain the slag, only one of the three non-transferred arc torches 14, 15 and 16 is activated at any one time, taking turns to respectively induce, via a mechanical effect of their homogeneous plasma flow 21, 22, the passing of the slag through the openings of the corresponding notches 27-29. Said operation is repeated as often as necessary. The slag is collected inside the catchment basins (not illustrated). It should be noted that the height of each notch is adjusted to take account of the decreasing level 17 of the molten bath 13 during evacuation of the slag. Hence, the notch 29 is lower down than the notch 28, which itself is below the notch 27.
The purified silicon plasma is transferred into a controlled solidification device (not illustrated in FIG. 1 for clarity reasons), via a semi-continuous flow, positioned within the axis of the base 30 of the melting pot 1; for example, due to reheating via an electromagnetic field produced by the coil 31.
Said controlled solidification device is positioned beneath the melting pot 1 and is made leak-proof in relation to the latter, by the interface 32, as of when the flow is initiated.
The volume of the solidification device being more limited than that of the melting pot 1, several controlled solidification devices 33-37 shall be successively presented (FIG. 4). This may be achieved, for example, through a horizontal movement of the latter, such devices being placed beneath the melting pot 1 by way of a vertical movement. As an illustration, said solidification devices 33-37 are mounted onto a wagon 38 in order to adopt a linear or circular presentation.
Measuring and control devices enable to detect the temperature and the pressure inside the melting/purification enclosure 2, the level of the molten bath 13 and the purification grade of the material.

In said apparatus, the purification method comprises the following phases:
a/ a flow of crushed metallurgical silicon is transported, for example by means of a carrier gas, and is then injected downwards in a substantially vertical manner into a homogeneous plasma flow obtained by collision with a solid wall of a plasma jet, emitted by a non-transferred arc torch fuelled by an inert gas, e.g. argon, basically running at its nominal power.
   The pre-heated silicon flow is simultaneously subjected to an “in flight” purification (primary purification) of the impurities that may be vaporised by means of the chosen carrier gas brought up to a high temperature via the homogenous plasma flow, for example chlorine or hydrogen chloride, the silicon plasma/particles exchange surface being enhanced due to the finely divided state of the incoming crushed load,
b/ the diphasic mixture is directed downwards in a substantially vertical manner into a melting/purification pot (second purification), basically in accordance with the vertical axis of the latter, in order to constitute a pre-melted bath of pre-purified material, the melting pot having limited volume due to its walls being made of an ultra pure material kept at a stable temperature and being non-contaminating in relation to silicon load.
c) when the melting pot is filled with a pre-melted bath under the action of the plasma via inert gas, injection of the metallurgical crushed silicon load is interrupted, the plasma power of the non-transferred arc torch fuelled in inert gas is then reduced and the chemical function of the carrier gas remains active in order to continue purification in the melting pot,
d/ electromagnetic heating guarantees the overall melting of the bath and its stable temperature, thereby inducing further stirring in order to homogenise the latter and to ensure diffusion of the impurities in the direction of the bath's surface,
e/ then is delivered, vertically above the bath and towards the latter's surface, a second dedicated homogenised plasma, by way of a plasma-forming gas with an evolving composition, for example a mixture of oxygen, hydrogen, carbon dioxide, and possibly hydrogen chloride, at the point of elimination, on the silicon bath's surface (third purification), using specific thermochemical reactions.
   Said plasma is also generated by one or several other non-transferred arc plasma torches. It is also used for its mechanical effects enabling to evacuate, laterally and at regular intervals, the slag film that may be formed on the surface of the bath, due to the additional reactions between the plasma and the silicon, particularly silicon dioxide. Said film should be evacuated since it reduces the efficiency of the plasma dedicated to eliminating the impurities on the surface.
   A variant is planned in order to evacuate the slag film, notably its vaporisation by way of a specific plasma-forming gas having the ability to vaporise said film, providing a chemical “cleansing” at regular intervals.
f/ when the silicon bath is purified of all its impurities that may be vaporised by the actions of the thermal plasma, the flow is initiated in order to transfer the bath to the crystallization device, the heating via electromagnetic induction being maintained within a range of appropriate power, as well as, if necessary, the inert gas plasma remaining under reduced power.
   The method described above thus allows a primary “in flight” elimination of the impurities (first purification) on the particles of the crushed load within the inert plasma-forming gas/carrier gas mixture of the central torch fuelled with inert gas, followed by a second purification on the surface of the bath continuously supplied with residual impurities by electromagnetic stirring.
   For a load of metallurgical silicon, the impurities extracted involve phosphorus and metallic impurities, for example Fe, Ti, in the form of gaseous chloride.
   Several lateral torches fuelled by the reactive mixture of plasma-forming gas, such as oxygen, hydrogen, carbon dioxide and even hydrogen chloride, enable vaporisation on the surface of the bath of other impurities through oxidization.
   Boron is transformed into a BOH gaseous chemical formula compound, whereas the carbon is oxidized into carbon monoxide.
   Resulting from said plasma processing is silicon that still contains impurities, though only made up of metallic chemical elements whose contents is compatible with the last extraction via segregation in the controlled solidification process, notably Cu, V, Al, Cr.
   It should be noted that the erosion of the electrodes of the arc torches produces such metallic elements as Cu and Cr, in minimal quantities, and which are eliminated by segregation during the controlled solidification phase.
   In the context of processing a metallurgical silicon load, said process advantageously enables the optimal use of the plasma for the following reasons:
   a pre-melting thermal function of the metallurgical silicon, initially with only slight thermal conductor properties, both “in flight” and in the melting pot,
   a first and second purification function, coupled with the thermal function, within the initial injection phase of the material inside the plasma and inside the melting pot, via a combined action using carrier gas,
   a third purification function on the surface of the bath formed by a specific plasma that evolves in terms of its composition,
   continuity between all the thermal and chemical functions.
      It should be noted that the generation of arc plasma is not very sensitive to the injection of pulverulent metallurgical silicon, which makes it particularly effective for this type of application. In other words, the functioning and the performances of the non-transferred arc plasma torch connected to the injection enclosure are not modified, or only very marginally, due to the injection of the material; hence, the efficiency of the method is only linked, as regards the plasma, to the optimisation of the thermal and chemical transfers of the torch's plasma in the direction of the material to be processed.
      Furthermore, the configuration retained guarantees that all the silicon shall be effectively processed.
      Said purification method offers a very favourable energy report:
   on the one hand, the electromagnetic and plasma energy sources are respectively used for maximal energy transfer to the metallurgical crushed silicon load, namely
   by the plasma, a first preheating of the particles “in flight” within the plasma, then a pre-melting bath,
   via electromagnetic induction, an overall melting and its maintenance (the electromagnetic thermal transfer is thus more efficient than the plasma thermal transfer),
      On the other hand, said method does not present any thermal break (such as heating/cooling down/re-heating), nor in particular any other silicon heating than the initial heating, thereby enabling a transfer of the bath directly towards the final solidification process.
      In a particular implementation method, and as simple illustration, an industrial purification plant comprises the following main characteristics:
   the interior diameter of the melting pot 1 a is approximately 1.5 meters,
   the height of the bath is approximately 0.2 meters,
   the plasma power of the torch 3 is approximately one Megawatt, while the unit power of each lateral torch, 14 or 15 or 16, is approximately 300 kW,
   the power of the electromagnetic heating device is approximately one Megawatt,
   the metallurgical silicon flow is approximately 500 Kg/hour.

Bearing in mind a yield of 80% of the materials upon output from the melting/purification pot and an overall processing time by batches of 1 hour, the capacity of one production unit of purified silicon is approximately 400 kg/hour.

1-27. (canceled)

28. A method for purifying a silicon-based load in order to obtain extra-pure silicon, characterised in that the following steps are embodied:
a) a plasma jet generated by an initial non-transferred arc torch (6) is directed onto a solid wall (7) of a volume equipped with an outlet so that the impact of said jet against said solid wall (7) inside said volume generates a homogeneous plasma flow,
b) a silicon-based load to be processed, constituted of particles and/or grains, or crushed, is continuously injected into said homogeneous plasma flow,
c) the assembly formed by the homogeneous plasma into which the load has been injected is continuously directed from the outlet of said volume towards a melting pot (1) equipped with lateral walls and a base (30) and an open upper part, said melting pot (1) comprising means for heating and stirring (12) said load into a molten state,
d) once the entire load has been injected and a molten bath (13) has been formed inside said melting pot (1), the reactive plasma jet from at least a second non-transferred arc torch (14-16) is directed onto the surface (17) of said bath in order to volatilize at least certain impurities from the molten bath (13) existing on the surface (17) of said bath,
e) the slag on the surface (17) of said bath is removed, and steps d) and e) are possibly repeated in order to volatilize at least some of the impurities of the bath brought to the surface (17) of said bath due to stirring,
f) said molten bath (13) is then emptied.

29. The method according to claim 28, characterised in that at least one said reactive plasma jet is a homogeneous and reactive plasma flow obtained through the impact of the reactive plasma jet generated by way of at least a second said non-transferred arc torch (14-16) against a solid wall (7) of another volume equipped with an outlet, said second torch (14-16) being connected to said other volume.

30. The method according to claim 28, characterised in that in step b), said load having been injected by means of a carrier gas, the ratio of the load mass to be processed on the carrier gas mass is above 20.

31. The method according to claim 30, characterised in that said carrier gas being a reactive gas in contact with the homogeneous plasma flow, a first purification of said load is embodied within said homogeneous plasma flow.

32. The method according to claim 28, characterised in that in step d), said melting pot (1) having a diameter D and a height H, namely D/H≧5, reactive plasma jets from at least a second and a third non-transferred arc torch (14-16) are dispatched onto said surface (17) of said molten bath (13) in order to volatilize at least some of the impurities from the molten bath (13) present on the surface (17) of said bath.

33. The method according to claim 28, characterised in that in step f), the molten bath, now purified of its impurities via plasma, is emptied by controlling its speed of extraction, its temperature of extraction and the amount extracted.

34. The method according to claim 28, characterised in that the spatial volume of said homogeneous plasma flows is increased in order to avoid projections inside said melting pot (1) in step c) and in order to process a greater surface (17) of said molten bath (13) than in step d).

35. A purification apparatus for the implementation of the purification method according to claim 28, characterised in that it comprises:
an injection enclosure (4) comprising at one end a non-transferred arc plasma torch (6) having a main axis, said torch being designed to generate a plasma jet with a propagation axis essentially centred on the main axis of said torch,
said injection enclosure (4) comprising an angled portion equipped with an outlet, said angled portion positioned downstream of said plasma torch (6) comprising a solid wall (7) so that said plasma jet collides with said solid wall (7) in order to form a homogeneous plasma flow,
said injection enclosure (4) comprising at least one insertion port (5) located downstream of said plasma torch (6) for the continuous insertion of a load to be processed, comprised of particles and/or grains, or crushed, in view of its mixing with said homogeneous plasma flow,
the outlet of said injection enclosure (4) is placed above a melting pot (1) equipped with lateral walls and a base (30) and an open upper part, said melting pot (1) being adapted to continuously receive said assembly formed by the homogenous plasma flow into which said load is injected until complete insertion of the load for forming a molten bath (13),
said melting pot (1) comprising means for heating and stirring (12) said molten bath (13) in a molten state, with one or more extraction ports (27-29) placed on its lateral walls in order to evacuate the slag and at least one discharge port in order to empty said molten bath (13),
said apparatus comprising one or several other non-transferred arc plasma torches (14-16), each one for the purpose of generating a reactive plasma jet dispatched onto the surface (17) of the molten bath (13) in order to volatilise at least some of the surface impurities of said molten bath (13).

36. The apparatus according to claim 35, characterised in that said angled portion comprises at least a flared-shape portion (9) in order to enable absorption of the load flow injected into said homogeneous plasma flow, said flared-shape portion (9) comprising at its tip the outlet for said injection enclosure (4), and characterised in that each of the said other non-transferred arc plasma torches (14-16) generating a reactive plasma jet are linked to a corresponding homogenisation enclosure comprising an angled portion placed downstream of said corresponding plasma torch, said angled portion comprising at least one flared-shape portion (23, 24) on the tip of which is placed the outlet of said corresponding homogenisation enclosure.

37. The apparatus according to claim 35, characterised in that said apparatus comprises means for individually adjusting the distances between the outlets of the injection enclosure (4) and the homogenisation enclosure, of the bottom of the melting pot (1) or the surface (17) of said molten bath (13) in order to optimise the energy reports and the extraction of the impurities.

38. The apparatus according to claim 35, characterised in that said solid wall (7) with which the plasma jet collides is placed in relation to the outlet of said torch linked to said injection enclosure (4), inside an area where the measured temperature of the plasma jet within the axle of said plasma jet, failing existence of said solid wall (7), would be equal or substantially equal to half the value of the average peak temperature of the plasma jet measured at the output of said non-transferred arc torch.

39. The apparatus according to claim 35, characterised in that said load having been injected using a carrier gas, at least one said apparatus equipped with at least one load injection port (5) comprises at least one nozzle enabling a rotary injection of said load.

40. The apparatus according to claim 35, characterised in that said apparatus comprises means for adjusting the composition of the plasma-forming gas of each of the non-transferred arc torches during operation of the latter.

41. The apparatus according to claim 35, characterised in that said melting pot (1) has a diameter D and a height H, namely D/H≧5.

42. The apparatus according to claim 36, characterised in that said apparatus comprises means for individually adjusting the distances between the outlets of the injection enclosure (4) and the homogenisation enclosure, of the bottom of the melting pot (1) or the surface (17) of said molten bath (13) in order to optimise the energy reports and the extraction of the impurities.

43. The method according to claim 32, characterised in that in step b), said load having been injected by means of a carrier gas, the ratio of the load mass to be processed on the carrier gas mass is above 20.
